(19) United States
(12) Patent Application Publication
(10) Pub. No.: US 2018/0192803 A1
(43) Pub. Date: Jul. 12, 2018

(54) EDIBLE STRAW FOR DRINK CONSUMPTION

(71) Applicant: Sorbo MJV S.L., Sant Fost De Campsentelles, Barcelona (ES)

(72) Inventors: Enric JUVIÑA, Sant Fost De Campsentelles (ES); Carlos ZORZANO, Sant Fost De Campsentelles (ES); Vitcor SANCHEZ TOLEDO, Sant Fost De Campsentelles (ES); Michael BARAFFE, Sant Fost De Campsentelles (ES); Albert MONFERRER BALLESTER, Sant Fost De Campsentelles (ES)

(21) Appl. No.: 15/572,504

(22) PCT Filed: May 4, 2016
(86) PCT No.: PCT/ES2016/070342

§ 371 Date: Nov. 8, 2017

(30) Foreign Application Priority Data
May 8, 2015 (ES) P201530630

(51) Int. Cl. A47G 21/18; A23P 30/20; A23G 3/50

(52) U.S. Cl. CPC A47G 21/18; A23V 2002/00; A23G 3/50; A23P 30/20

(57) ABSTRACT

The present invention relates to a straw made of an edible material for drink consumption comprising the following ingredients: water, gelling agent, sugar, a stabilising or thickening agent, and a plasticising or humectant agent. The present invention also relates to a method for obtaining the edible straw as well as to the straw obtained thereby and its use for drink consumption.

### FIELD OF THE INVENTION

The present invention falls within the field of foodstuffs.

Specifically, the present invention relates to a straw made of an edible material for drink consumption that at least comprises the following ingredients in the following percentages by weight of the total of the composition, such that the total amount thereof does not exceed 100% of the composition:

| Ingredients: | Weight % |
|---|---|
| Water: | 3%-15% |
| Gelling agent: | 0.5%-2% |
| Sweetening agent: | 75%-90% |
| Stabilising/thickening agent: | 0.5%-2% |
| Plasticising/humectant agent: | 0.10%-1.5% |

The present invention additionally comprises aromas, flavours and colorants. The present invention also relates to a method for obtaining the edible straw as well as to the straw obtained thereby and its use for drink consumption.

### BACKGROUND OF THE INVENTION

A “straw” commonly refers to a thin tube or similar artificial pipe for sucking up liquids, especially drinks.

Thus, straws are well known and widely used for drink consumption. Generally, drinking straws comprise an elongated cylindrical pipe defining a lumen through which a liquid drink may be channelled into the mouth of a consumer.

Thus, the drinking straw is a tool used to transfer a liquid from one place to another, usually used in drinks, such as to transfer liquids from a glass to the mouth. The Sumerians made the most primitive straws from plant stems. In various cultures dry and hollow reeds were used for similar purposes, being the stems or straw (of various thicknesses) of wheat, barley or rye, among others, the most widely used, and hence the name of straws for the thin ones.

Straws were initially offered to the market as an option to reduce the risk of catching a disease from improperly washed containers, glasses and cups.

Essentially, the straw comprises a distal end that is submerged in the drink to be consumed, the latter being drawn upwards by a vacuum force created by the mouth of the user on the opposite end of the straw.

Straws consisting of a hollow pipe or channel, through which the liquid comes out, generally made of plastic or polyethylene, straight or accordion-shaped at the tip to form an elbow, are also well known.

The vast majority of drinking straws are made of plastic. However, these types of plastic straws have a number of significant problems: for example, they are not biodegradable. In addition, these plastic straws are discarded after use, being a major source of pollution.

Furthermore, the fact that it is a disposable product means that it has neither functionality nor contributes to the food in which it is introduced. Therefore, besides its mechanical functionality (facilitating drink intake), it could have an additional functionality related to organoleptic and nutritional aspects.

For this reason, the inventors of the present invention have developed a functional straw capable of functioning as a nutritional food product or nutritional supplement, complementing the ingested drink with essential nutrients, having the dual function as straw and as nutritional complement, having the basic technical advantages of being biodegradable and remaining rigid without deforming even when submerged in cold drinks for a period of time up to 1 hour, without releasing colorants into the drink and without aromatising it or altering its organoleptic characteristics. That is, the straw object of the present invention is very stable over time and fully functional, as it allows the user to use it for a suitable period of time without releasing substances into the drink in which it is inserted (neither colorants nor aromas nor flavours).

The inventors of the present invention have conducted a search to find the most relevant background regarding edible straws.

In the searches conducted for Spain, no patent documents have been found describing an edible straw, but straws including within them compositions of active substances such as vitamins and other nutritional substances for oral administration have indeed been found. For example, the Spanish patent ES2286422 describes a way for oral administration of active substances, vitamins and/or nutritional substances, which are retained in a section of a straw, so that when sucking the liquid the formulation is dissolved and consumed by the user.

Within Spain, the state of the art describes various stirrers and teaspoons that may contain substances to be dissolved or even be edible and dissolved when stirring the drink. One example of this case is the Spanish utility model ES1059718U, which describes an edible sweetener teaspoon preferably intended for use in the consumption of herbal teas and other drinks. The teaspoon has a functional part (1), oval-shaped or similar, made from a sweetener material in solid and firm state, but dissolvable in a liquid, while the handle (2) consists of a piece of a solid state and edible product coupled to the functional part (1) by means of a firm attachment until the dissolution of said part. However, the tool itself is not eaten.

Regarding international-level searches, some documents describing edible straws have been found. For example, the document US2006286214A1 relates to an edible drinking straw having a first layer of a fruit film coated with a solution of zein (which is a protein), and rolled up in a spiral. Subsequent layers of the fruit film can be rolled up over the first layer, each subsequent layer being attached to the previous layer with an adhesive. However, this American application has a different composition, since no fruit film is used but rather sugars as main component. Further, the straw object of the present invention, unlike the American patent, is not formed of layers, since, as a result of extrusion, a single cylindrical piece is obtained, wherein the fact of having a smooth surface provides the advantage of being able to screen-print on it by means of laser techniques, which provides a marketing advantage.

Furthermore, the inventors of the present invention have found the document US2004013772A1, which relates to an edible drinking straw with fortifying nutritional supplements. This American invention describes a straw rich in edible nutrients to use in drink consumption. The straw can have one or more tablets, fruit powders of natural flavour, natural colour and moisturising properties. The straw is manufactured by extrusion, it may be coated with wax, and the rate at which it is dissolved in the drink can be regulated by the formulation thereof. As with the other American patent, the composition is different from the object of the present invention since no fruit film is used, but rather sugars as the main component. Furthermore, the straw object of the present invention, unlike the American patent, is not formed by layers, since, as a result of extrusion, a single cylindrical piece is obtained, wherein the fact of having a smooth surface provides the advantage of being able to screen-print on it by means of laser techniques, which provides a marketing advantage.

Given the above, the inventors of the present invention have decided to obtain a straw such that it actually may be used as a vehicle to improve the organoleptic properties of a drink or to simply complement the flavour of the drink, while at the same time providing essential nutrients.

Furthermore, the researchers of the present invention have determined a straw with the advantage that it is durable enough for a reasonable period of time without dissolving or disintegrating.

### DETAILED DESCRIPTION OF THE INVENTION

The present invention relates to a straw made of an edible material for drink consumption that overcomes the limitations of the state of the art and has the following advantages:
Versatility: it may be used in different types of drinks and have different flavours and/or aromas.
Durability: it will not come apart when submerged in the drink.
Flavour: the straw should have flavour but not undermine the flavour of the drink in which it is submerged. The flavours, by way of example and not limitation, are grapefruit, lime, lemon, orange, strawberry and salty flavour.
Texture/Feel: the feel of the straw should be pleasant and not sticky.
Aesthetics: the straw should be eye-catching and be set apart from a conventional straw.
Rigidity: it should remain rigid in contact with the liquid.
Hygiene: it should comply with food regulations.

After evaluating various options, the researchers chose to try to use the paste for pastillage used in confectionery as base. Pastillage is a confectionery decoration characterised by forming a mouldable paste that, when dry, is rigid and hard. Icing sugar is its main ingredient. The traditional recipe mixes the icing sugar with gelatin and allows for the incorporation of aromas and colorants.

For the present invention the pastillage base formula has also been modified so that it can be extruded in an “Italian-pasta-type” machine.

The present invention relates to a straw made of an edible material for drink consumption comprising the following ingredients:

| Types of ingredients: | Examples of ingredients |
|---|---|
| Water: | Fruit juice |
| Gelling agent: | Gelatin, carrageenan, agar, pectin, combination of |
| | carrageenan with locust bean gum, combination |
| | of xanthan with locust bean gum |
| Icing sugar: | Powdered dextrose, powdered sorbitol, |
| | isomaltose, lactitol, maltitol |
| Stabiliser/Thickener: | Carboxymethylcellulose, xanthan, guar, tara, |
| | pregelatinised starch, konjac |
| Plasticiser/humectant: | Glycerine, propylene glycol, glucose syrup, liquid |
| | sorbitol |
| Aromas: | Natural fruit extracts, essential fruit oils, aromatic |
| | salts, etc. |
| Colorants: | Plant concentrates |
| Moisturisers: | Water, fruit juice, milk, etc. |

The functions of each of the ingredients are as follows:
Water: Necessary for gelatin and carboxymethylcellulose to moisturise and to perform their function.
Gelling agent: it forms a flexible protein framework that holds together the other ingredients providing plasticity and flexibility.
Sugar: (icing sugar as preferred form) it provides structure when dried. It forms the frame of the small tube. It gives flavour. It keeps because the water activity in these concentrations is very low.
Stabiliser/thickener: It facilitates, along with the gelling agent such as gelatin, the formation of the paste or conglomerate with the other ingredients. When dried it tends to form a film that provides rigidity to the small tube. It facilitates extrusion.
Plasticising/humectant agent: It prevents the small tube from breaking apart when extruded or dried.
Aroma: It provides flavour and characteristic smell.
Colorant: It provides the identifying colour of the corresponding flavour.
Moisturiser: It improves the texture and the organoleptic properties.

The straw object of the present invention comprises at least the following ingredients in the following percentages by weight of the total of the composition, such that the total amount thereof does not exceed 100% of the composition:

| Ingredients: | Weight % |
|---|---|
| Water: | 3%-15% |
| Gelling agent: | 0.5%-2% |
| Sweetening agent: | 75%-90% |
| Stabilising/thickening agent: | 0.5%-2% |
| Plasticising/humectant agent: | 0.10% 1.5% |

Preferably the gelling agent is gelatin, the sugar is icing sugar, the stabiliser is carboxymethylcellulose and the plasticiser is glycerine. The present invention additionally comprises aromas, flavours and/or colorants. The present invention additionally comprises moistening agents, such as fruit juice, milk, etc.

The aromas and colorants are accessories and may vary depending on the final product obtained. Table 1 below shows a list of possible aromas and colorants, which by no means has been included by way of limitation:

TABLE 1

| | | Weight %* |
|---|---|---|
| STRAWBERRY | Aroma | 0.30 |
| | Colour | 0.01 |
| LEMON | Aroma | 0.60 |
| | Colour | 0.01 |
| LIME | Aroma | 0.60 |
| | Colour | 0.10 |
| ORANGE | Aroma | 0.80 |
| | Colour | 0.10 |
| GRAPEFRUIT | Aroma | 1.10 |
| | Colour | 0.05 |

*The percentage doses of aromas and colours may be adjusted depending on the desired result.

The researchers conducted several studies in order to determine the list of essential ingredients of the edible straw formulation.

Among the tests conducted to reduce the rigidity of the straw initially obtained, it was decided to use a controlled drying method, so that the product was less dried. The resulting small tube was no longer rigid, was more pleasant to chew, and still lasted long enough submerged in the drink. Unfortunately the straw obtained was somewhat friable and cracked under pressure. For this reason the straw formulation was changed again to prevent friability.

Finally, it was concluded that the optimum straw and therefore object of the present invention comprises at least the following ingredients in the following percentages by weight of the total of the composition, such that the total amount thereof does not exceed 100% of the composition:

| Ingredients: | Weight % |
|---|---|
| Water: | 3%-15% |
| Gelling agent: | 0.5%-2% |
| Sweetening agent: | 75%-90% |
| Stabilising/thickening agent: | 05%-2% |
| Plasticising/humectant agent: | 0.10%-1.5% |

Wherein preferably the gelling agent is gelatin, the sugar is icing sugar, the stabiliser is carboxymethylcellulose and the plasticiser is glycerine. And it is compatible with any aroma or colorant. The present invention additionally comprises aromas, flavours and/or colorants.

The straw object of the present invention has the substantial technical advantage of remaining rigid without deforming in cold drinks for a period of time up to 1 hour, without releasing colorants into the drink and without aromatising or altering the organoleptic characteristics of the drink.

The present invention also relates to a method for obtaining the edible straw.

To determine the key steps of the method the inventors of the present invention conducted different tests mixing various ingredients and evaluating the ability of the pastes to be extruded, dried and moisture resistant when submerged both in a soft drink and an alcoholic drink.

Thus, the method for obtaining the edible straw of the present invention comprises the steps of:
a) Preparing the paste,
b) Extruding the paste at a temperature range between 5 and 50° C., obtaining a primary small tube or straw,
c) Pre-drying the paste extruded in step b) with cold air at a temperature between 0° C. and 10° C. for a period of time of 2 to 10 minutes.
d) Cutting the small tube to the desired size, and
e) Drying the small tube in an oven at a temperature range between 40° C. and 80° C. for 2-3 hours until obtaining a maximum moisture of 12%.

Additionally the method object of the present invention comprises the steps of:
f) Screen-printing with laser, a step which provides marketing advantages to the product, since it allows advertising to be included on the straw, and
g) Packaging.

In turn, step a) of the method (preparing the paste) comprises the following sub-steps:
a.1) Cold moisturising of a gelling agent with water,
a.2) Pre-mixing a stabilising agent with sugar,
a.3) Heating the water with the gelling agent to 50-60° C. to dissolve it,
a.4) Adding the solution of step a.3) and the pre-paste of step a.2) in a kneader,
a.5) Kneading at a temperature between 25 and 35° C. and adding more gelling agent to the product obtained in step a.4), and
a.6) Continuing to knead and adding the rest of the sugar until a homogeneous paste is obtained.

Preferably aromas and colorants are added. If the aromas and colorants are in solid state they are additionally added in step a.2) and if the aromas and colorants are in liquid state they are additionally added in step a.6).

Important aspects to consider: During the kneading it is preferable to maintain a temperature between 25-35° C. If the temperature is lower, the paste becomes very thick and hard to work with, but if the kneader is able to work it, there is no problem with it being colder. If the temperature is higher, the paste is fluid and sticky. It will then have to rest before extrusion, making it more difficult to empty the hopper.

### 2. Extrusion Process:

The temperature of the paste to be extruded should be adjusted according to the characteristics of the extruder and drying line/area. The colder the paste enters, the harder the extrusion is, but the earlier it can be cleanly cut.

In the tests conducted in laboratory, the researchers extruded in a range between 20 and 50° C. because the test extruder could not work with very compact paste. If the industrial machine is capable of doing so, it is better to work with the paste colder, for example between 5 and 50° C., to facilitate cutting and drying. After the extrusion process a primary small tube or straw is obtained.

### 3. Pre-Drying:

It is a step prior to subsequent cutting and drying. The inventors of the present invention have found that they obtain a better result cutting when pre-drying in a tunnel is performed. Preferably the step of pre-drying is performed with cold air at a temperature between 0° C. and 10° C. for a period of time of 2 to 10 minutes.

### 4. Cutting and Drying:

The cutting of the small tube or primary straw should be performed when the paste is not hot since the walls of the cutting area would stick. If the machine can extrude with the paste cold, there will be no problem.

A few minutes after extrusion, the small tubes are superficially dried and are dry to the touch and flexible. If a rigid, hard and fully dry small tube is desired, it should be placed in a drying tunnel (or in a conditioned chamber and dried on trays) to remove the added water. The temperature and drying time depend on the tunnel characteristics, the air renewal, the fan power and the relative moisture of the air flowing. In the laboratory tests, drying was carried out in an oven at a temperature range between 40° C. and 80° C. for 2-3 hours (static and non-renewed air) until obtaining a maximum moisture of 12%.

5. Screen-Printing, Burning with Laser:

This step provides marketing advantages to the product, since it allows advertising to be included on the straw.

### 6. Packaging and Preserving:

Moisture is the main enemy of this product. This is a very stable product as it has very low water activity (a_{w}), such that microorganisms cannot grow. The small tubes should be packaged cold (to avoid condensation) and in a moisture-impermeable packaging.

If condensation appears in the packaging or it is permeable to moisture, mould or yeast could grow on the surface of the small tube.

It is recommended to keep the product in a cool, dry place. It is advisable to instruct the end users not to store or keep them next to machines that are heated, such as coffee makers.

An object of the present invention is therefore a straw made of an edible material for drink consumption comprising the following ingredients in the following percentages by weight of the total of the composition, such that the total amount thereof does not exceed 100% of the composition:

| Ingredients: | Weight % |
|---|---|
| Water: | 3%-15% |
| Gelling agent: | 0.5%-2% |
| Sweetening agent: | 75%-90% |
| Stabilising/thickening agent: | 0.5%-2% |
| Plasticising/humectant agent: | 0.10%-1.5% |

According to another aspect of the straw, the gelling agent is selected from the group formed by gelatin, pectin, xanthan gum and carrageenan as well as mixtures thereof.

According to another aspect of the straw, the sweetening agent is selected from the group formed by cane sugar, refined sugar, icing sugar, brown sugar, fructose, honey, steviol and sucrose, as well as mixtures thereof.

According to another aspect of the straw, the stabilising agent is selected from the group formed by locust bean gum, alginates and carboxymethylcellulose, as well as mixtures thereof.

According to another aspect of the straw, the plasticising agent is selected from the group formed by glycerine, sorbitol and glycerol, as well as mixtures thereof.

According to another aspect, the straw additionally comprises aromas, flavours and/or colorants.

According to another aspect, the straw additionally comprises moistening agents.

According to another aspect, the invention relates to a method for obtaining the edible straw comprising the following steps:
a) Preparing the paste,
b) Extruding the paste at a temperature range between 5 and 50° C., obtaining a primary small tube or straw,
c) Pre-drying the paste extruded in step b) with cold air at a temperature between 0° C. and 10° C. for a period of time of 2 to 10 minutes.
d) Cutting the small tube to the desired size, and
e) Drying the small tube in an oven at a temperature range between 40° C. and 80° C. for 2-3 hours until obtaining a maximum moisture of 12%.

According to another aspect, the invention relates to a method for obtaining the edible straw additionally comprising the following steps:
f) Screen-printing with laser to include advertising on the straw, and
g) Packaging.

According to another aspect, the invention relates to a method for obtaining the edible straw in which step a) comprises the following sub-steps:
a.1) Cold moisturising of a gelling agent with water,
a.2) Pre-mixing a stabilising agent with sugar,
a.3) Heating the water with the gelling agent to 50-60° C. to dissolve it,
a.4) Adding the solution of step a.3) and the pre-paste of step a.2) in a kneader,
a.5) Kneading at a temperature between 25 and 35° C. and adding more gelling agent to the product obtained in step a.4), and
a.6) Continuing to knead and adding the rest of the sugar until a homogeneous paste is obtained.

According to another aspect, the invention relates to a method where aromas, flavours and/or colorants are added in a sub-step.

According to another aspect, the invention relates to a method in which if the aromas, flavours and/or colorants are in solid state they are additionally added in step a.2) and if the aromas and colorants are in liquid state they are additionally added in step a.6).

According to another aspect, the invention relates to a method in which moistening agents are added in a sub-step.

According to another aspect, the invention relates to the straw obtained by the above method, characterised in that it remains rigid without deforming in cold drinks for a period of time up to 1 hour.

According to another aspect, the invention relates to the straw obtained by the above method, characterised in that it is biodegradable.

According to another aspect, the invention relates to the use of the aforementioned straw for drink consumption.

### Exemplary Embodiments

The exemplary embodiments indicated below are provided by way of illustration and not limitation, with the aim of a better understanding of the invention.

### Example 1: Formulation of a Sweet Edible Straw

A straw object of the present invention is obtained, comprising the following ingredients in the following percentages by weight of the total of the composition, such that the total amount thereof does not exceed 100% of the composition:

| Ingredients: | Weight % |
|---|---|
| Water: | 3%-15% |
| Gelatin: | 0.5%-2% |
| Icing sugar: | 75%-90% |
| Carboxymethylcellulose | 0.5%-2% |
| Glycerine: | 0.10%-1.5% |
| Strawberry aromas: | 0.30% |
| Strawberry colorant: | 0.01% |

Laboratory tests were conducted, determining that the straw object of the present invention has a substantial technical advantage of remaining rigid without deforming in cold drinks for a period of time up to 1 hour, without releasing colorants into the drink and without aromatising or altering the organoleptic characteristics of the drink, in this case water.

### Example 2: Method for Obtaining the Straw of Example 1

To determine the key steps of the method, the inventors of the present invention conducted different tests mixing various ingredients and evaluating the ability of the pastes to be extruded, dried and moisture resistant when submerged both in a soft drink and an alcoholic drink.

Thus, the essential steps in extended form are:

### a) Paste Preparation:

A step comprising in turn the following sub-steps:
a.1) Cold moisturising the gelatin with water,
a.2) Pre-mixing carboxymethylcellulose (CMC) with sugar,
a.3) Heating the water with the gelatin at 50-60° C. to dissolve it,
a.4) Adding the solution of gelatin and the pre-paste of step a.2) in a kneader,
a.5) Kneading at a temperature between 25 and 35° C. and adding the glycerine to the product obtained in step a.4), and
a.6) Continuing to knead and adding the rest of the sugar until a homogeneous paste is obtained.

Preferably aromas and colorants are added. If the aromas and colorants are in solid state they are additionally added in step a.2) and if the aromas and colorants are in liquid state they are additionally added in step a.6).

Important aspects to consider: During the kneading it is preferable to maintain a temperature between 25-35° C. If the temperature is lower, the paste becomes very thick and hard to work with, but if the kneader is able to work it, there is no problem with it being colder. If the temperature is higher, the paste is fluid and sticky. It will then have to rest before extrusion, making it more difficult to empty the hopper.

### b) Extrusion Process:

The temperature of the paste to be extruded should be adjusted according to the characteristics of the extruder and drying line/area. The colder the paste enters, the harder the extrusion is, but the earlier it can be cleanly cut.

In the tests conducted in laboratory, the researchers extruded in a range between 20 and 50° C. because the test extruder could not work with very compact paste. If the industrial machine is capable of doing so, it is better to work with the paste colder, for example between 5 and 50° C., to facilitate cutting and drying. After the extrusion process a primary small tube or straw is obtained.

### c) Pre-Drying:

It is a step prior to subsequent cutting and drying. The inventors of the present invention have found that they obtain a better result cutting when pre-drying in a tunnel is performed. Preferably the step of pre-drying is performed with cold air at a temperature between 0° C. and 10° C. for a period of time of 2 to 10 minutes.

### d) Cutting and Drying:

The cutting of the small tube should be performed when the paste is not hot since the walls of the cutting area would stick. If the machine can extrude with the paste cold, there will be no problem. A few minutes after extrusion, the small tubes are superficially dried and are dry to the touch and flexible.

If a rigid, hard and fully dry small tube is desired, it should be placed in a drying tunnel (or in a conditioned chamber and dried on trays) to remove the added water. The temperature and drying time depend on the tunnel characteristics, the air renewal, the fan power and the relative moisture of the air flowing. In the laboratory tests, drying was carried out in an oven at a temperature range between 40° C. and 80° C. for 2-3 hours (static and non-renewed air) until obtaining a maximum moisture of 12%.

e) Screen-Printing, Burning with Laser:

This step provides marketing advantages to the product, since it allows advertising to be included on the straw.

### f) Packaging and Preserving:

Moisture is the main enemy of this product. This is a very stable product as it has very low water activity (a_{w}), such that microorganisms cannot grow. The small tubes should be packaged cold (to avoid condensation) and in a moisture-impermeable packaging. If condensation appears in the packaging or it is permeable to moisture, mould or yeast could grow on the surface of the small tube.

It is recommended to keep the product in a cool, dry place. It is advisable to instruct the end users not to store or keep them next to machines that are heated, such as coffee makers.

1-16. (canceled)

17. A biodegradable straw made of an edible material for drink consumption comprising:
water in an amount of 3% to 15% weight,
a gelling agent in an amount of 0.5% to 2% weight selected from the group consisting of gelatin, pectin, xanthan gum and carrageenan and mixtures thereof,
sweetening agent in an amount of 75% to 90% weight selected from the group consisting of cane sugar, refined sugar, icing sugar, brown sugar, fructose, honey, steviol and sucrose and mixtures thereof,
stabilising/thickening agent in an amount of 0.5% to 2% weight selected from the group consisting of locust bean gum, alginates, carboxymethylcellulose and mixtures thereof, and
plasticising/humectant agent in an amount of 0.10% to 1.5% weight selected from the group consisting of glycerine, sorbitol and glycerol and mixtures thereof,
wherein said straw is friable when submerged in a drink, and
wherein said straw remains rigid without deforming when submerged in cold drinks for a period of time up to 1 hour, without either releasing colorants into the drink or altering its organoleptic characteristics.

18. The straw according to claim 17, further comprising aromas, flavours and/or colorants.

19. The straw according to claim 18, wherein the aromas and/or colorants are selected from the group consisting of strawberry, lemon, lime, orange and grapefruit.

20. The straw according to claim 17, further comprising moistening agents.

21. A method for obtaining a biodegradable straw made of an edible material for drink consumption comprising water in an amount of 3% to 15%, a gelling agent in an amount of 0.5% to 2%, a sweetening agent in an amount of 75% to 90%, a stabilising/thickening agent in an amount of 0.5% to 2% and a plasticising/humectant agent in an amount of 0.10% to 1.5%, wherein said straw is friable when submerged in a drink, and wherein said straw remains rigid without deforming when submerged in cold drinks for a period of time up to 1 hour, without either releasing colorants into the drink or altering its organoleptic characteristics, such method comprising the following steps:
a) Cold moisturising a gelling agent with water,
b) Pre-mixing carboxymethylcellulose with sugar,
c) Heating water with gelatin at a temperature between 50° C. and 60° C.,
d) Adding the gelating solution of step c) and the pre-paste of step b) in a kneader,
e) Kneading the mixture of step d) at a temperature between 25° C. and 35° C. and adding glycerin,
f) Adding the rest of the sugar while kneading,
g) Extruding the paste obtained in step f) at a temperature range between 5 and 50° C., obtaining a primary small tube or straw,
h) Pre-drying the paste extruded in step g) with cold air at a temperature between 0° C. and 10° C. for a period of time of 2 to 10 minutes,
i) Cutting the small tube to the desired size, and
j) Drying the small tube in an oven at a temperature range between 40° C. and 80° C. for 2-3 hours until obtaining a maximum moisture of 12%.

22. The method according to claim 21, further comprising the following subsequent steps:
k) Screen-printing with laser to include advertising on the straw, and
l) Packaging.

23. The method according to claim 21, wherein aromas, flavours and/or colorants are added in a sub-step.

24. The method according to claim 22, wherein aromas, flavours and/or colorants are added in a sub-step.

25. The method according to claim 23, wherein the aromas, flavours and/or colorants are in solid state, and are added in step b).

26. The method according to claim 24, wherein the aromas, flavours and/or colorants are in solid state, and are added in step b).

27. The method according to claim 23, wherein the aromas, flavours and/or colorants are in liquid state, and are added in step f).

28. The method according to claim 24, wherein the aromas, flavours and/or colorants are in liquid state, and are added in step f).

29. The method according to claim 21, wherein moistening agents are added in a sub-step.
